(19) United States
(12) Patent Application Publication
(10) Pub. No.: US 2020/0262555 A1
(43) Pub. Date: Aug. 20, 2020

(54) METHOD FOR DETECTING MOUNTING ERROR OF ACCELEROMETER, DEVICE, AND UNMANNED AERIAL VEHICLE

(71) Applicant: SZ DJI TECHNOLOGY CO., LTD., Shenzhen (CN)

(72) Inventors: Kang WANG, Shenzhen (CN); Zhenzhou LAI, Shenzhen (CN)

(21) Appl. No.: 16/690,495

(22) Filed: Nov. 21, 2019

Related U.S. Application Data
(63) Continuation of application No. PCT/CN2017/085461, filed on May 23, 2017.

(51) Int. Cl. B64C 39/02; G05D 1/10; H04W 4/02; G08G 5/00

(52) U.S. Cl. CPC B64C 39/024; G05D 1/106; B64C 2201/12; G08G 5/0017; H04W 4/027

(57) ABSTRACT

A method for detecting a mounting error of an accelerometer includes acquiring actual output data of the accelerometer mounted to an unmanned aerial vehicle (“UAV”) while the UAV is in a hover state. The method also includes determining a mounting error angle of the accelerometer based on the actual output data.

### CROSS-REFERENCE TO RELATED APPLICATION

This application is a continuation application of International Application No. PCT/CN2017/085461, filed on May 23, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of unmanned aerial vehicles (“UAVs”) and, more particularly, to a method for detecting a mounting error of an accelerometer, a device, and a UAV.

### BACKGROUND

Currently, a UAV is typically provided with an accelerometer. The accelerometer is mounted to the UAV through a structure. Mounting errors may occur during the mounting process, which may cause an error between an accelerometer coordinate system and a UAV body coordinate system after the UAV takes off. This error may be between 0.5 degree to 3 degrees, depending on the type of UAVs. The mounting error of the accelerometer may affect various flight performances of the UAV. The mounting error may cause more serious consequences, such as difficulty in controlling the UAV, which may cause a flight accident.

Current technology attempts to maintain the mounting accuracy during the manufacturing process, in which the mounting error may be reduced. However, maintaining the mounting accuracy through the manufacturing process costs a tremendous amount of labor and resources, which increases the manufacturing costs. In addition, in conventional technology, once the accelerometer is mounted in the UAV, it is difficult to perform subsequent detection and correction of the mounting error of the accelerometer mounted in the UAV.

### SUMMARY

In accordance with an aspect of the present disclosure, there is provided a method for detecting a mounting error of an accelerometer. The method includes acquiring actual output data of the accelerometer mounted to an unmanned aerial vehicle (“UAV”) while the UAV is in a hover state. The method also includes determining a mounting error angle of the accelerometer based on the actual output data.

In accordance with another aspect of the present disclosure, there is provided a device for detecting a mounting error of an accelerometer. The device includes a storage device configured to store program instructions. The device also includes a processor configured to retrieve the program instructions stored in the storage device, and to execute the program instructions to acquire actual output data of the accelerometer mounted to an unmanned aerial vehicle (“UAV”) while the UAV is in a hover state, and determine a mounting error angle of the accelerometer based on the actual output data.

According to the technical solutions of the disclosed method for detecting a mounting error of an accelerometer, the device, and the UAV, an amounting error angle of the accelerometer may be determined based on actual output data of the accelerometer acquired while the UAV is in a hover state. As such, under the condition that the accelerometer has already been mounted to the UAV, the mounting error of the accelerometer may be detected, thereby realizing monitoring the status of the mounting error of the accelerometer.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a method for detecting a mounting error of an accelerometer, according to an example embodiment.

FIG. 2 is a flow chart illustrating a method for detecting a mounting error of an accelerometer, according to another example embodiment.

FIG. 3 is a flow chart illustrating a method for detecting a mounting error of an accelerometer, according to another example embodiment.

FIG. 4 is a flow chart illustrating a method for determining a mounting error angle of an accelerometer, according to an example embodiment.

FIG. 5 is a schematic illustration of rotation conversion of actual output data of the accelerometer around an X axis of the accelerometer, according to an example embodiment.

FIG. 6 is a schematic illustration of rotation conversion of the rotation-converted actual output data around a Y axis of the accelerometer, according to an example embodiment.

FIG. 7 is a flow chart illustrating a method for determining a mounting error angle of an accelerometer, according to another example embodiment.

FIG. 8 is a flow chart illustrating a method for detecting a mounting error of an accelerometer, according to another example embodiment.

FIG. 9 is a schematic diagram of a device for detecting a mounting error of an accelerometer, according to an example embodiment.

FIG. 10 is a schematic diagram of a device for detecting a mounting error of an accelerometer, according to another example embodiment.

FIG. 11 is a schematic diagram of a determination unit, according to an example embodiment.

FIG. 12 is a schematic diagram of a determination unit, according to another example embodiment.

FIG. 13 is a schematic diagram of a device for detecting a mounting error of an accelerometer, according to another example embodiment.

FIG. 14 is a schematic diagram of a UAV, according to another example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Next, the embodiments of the present disclosure will be described in detail. Unless there is obvious conflict, the various embodiments or various features of various embodiments may be combined.

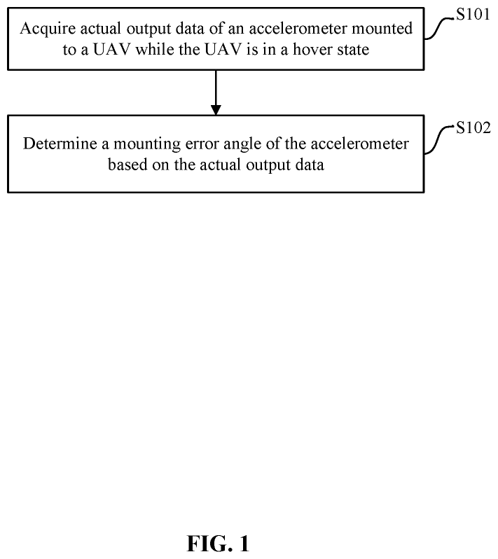

The present disclosure provides a method for detecting a mounting error of an accelerometer. FIG. 1 is a flow chart illustrating a method for detecting a mounting error of an accelerometer. As shown in FIG. 1, the method may include:

Step S101: acquiring actual output data of an accelerometer mounted to a UAV while the UAV is in a hover state.

In some embodiments, the UAV may be a multi-rotor UAV, such as a four-rotor UAV, a six-rotor UAV, an eight-rotor UAV, etc. A hover state is a flight state in which the UAV maintains a spatial location substantially unchanged at a specific height or altitude. When the UAV is in the hover state, it can be deemed that the total force provided by a propulsion system of the UAV cancels the gravity of the UAV, i.e., the total force and the gravity of the UAV have the same magnitude and opposite directions. The normal plane of the total force can be deemed as the horizontal plane. The horizontal plane is a plane that is perpendicular to the gravity of the UAV.

In some embodiments, the accelerometer of the present disclosure may be a single-axis accelerometer, a dual-axis accelerometer, or a three-axis accelerometer. In the present disclosure, a three-axis accelerometer is used as an example of the accelerometer in the following descriptions. In current technologies, the accelerometer and a gyroscope are typically integrated as a single module, i.e., an inertial measurement unit (“IMU”). When the IMU is mounted to the UAV, the mounting error angle of the accelerometer is substantially fixed (i.e., unchanged). When the UAV is in a hover state, the accelerometer may sense the current acceleration of the UAV. A processor of the UAV may acquire the actual output data of the accelerometer. That is, the processor of the UAV may acquire the actual output data of the three axes (X axis, Y axis, and Z axis) of the accelerometer.

Step S102: determining a mounting error angle of the accelerometer based on the actual output data.

In some embodiments, when the UAV is currently in a hover state, it can be deemed that the UAV is currently in a mechanical equilibrium state. Thus, the current actual output data of the accelerometer may indicate the mounting status of the accelerometer in the UAV. Accordingly, the mounting error angle of the accelerometer may be calculated based on the actual output data of the accelerometer.

According to the disclosed method for detecting the mounting error of the accelerometer, the mounting error angle of the accelerometer may be determined based on the actual output data of the accelerometer acquired while the UAV is in the hover state. Thus, under the condition that the accelerometer has been mounted to the UAV, the mounting error of the accelerometer may be detected, thereby realizing monitoring of the status of the mounting error of the accelerometer. Thus, during the manufacturing process or during the final product inspection, using the disclosed technical solutions, a UAV having a relatively large mounting error may be timely discovered, thereby maintaining product passing rate and the operation safety of the user.

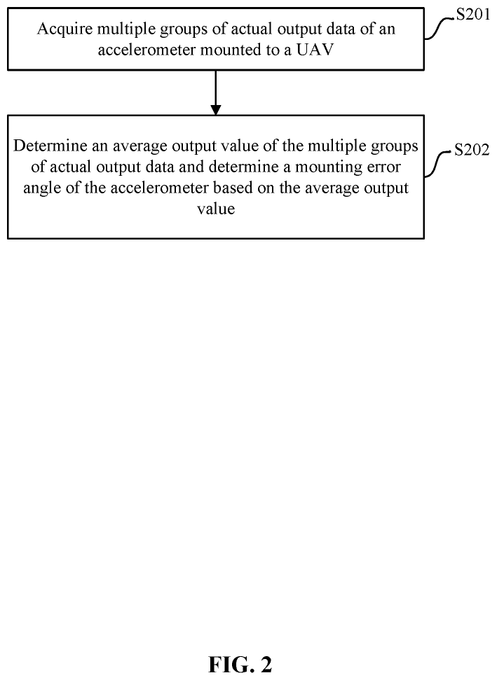

The present disclosure provides a method for detecting a mounting error of an accelerometer. FIG. 2 is a flow chart illustrating a method for detecting the mounting error of the accelerometer. As shown in FIG. 2, based on the embodiment shown in FIG. 1, the method shown in FIG. 2 may include:

Step S201: acquiring multiple groups of actual output data of an accelerometer mounted to a UAV.

In some embodiments, when the UAV is in the hover state, the accelerometer may output data at a predetermined frequency. The processor of the UAV may acquire multiple groups of actual output data of the accelerometer at a predetermined acquisition frequency. In some embodiments, the processor of the UAV may acquire the multiple groups of actual output data of the accelerometer at the predetermined acquisition frequency, in a predetermine time period, such as 1 s, 2 s, 3 s, 5 s, 6 s, 7 s, etc. The predetermined acquisition frequency may be, for example, 100 Hz, 150 Hz, 200 Hz, 250 Hz, 300 Hz, etc. When the UAV is in the hover state, multiple groups of actual output data of the accelerometer may be acquired. All of the acquired actual output data may be stored in a storage device of the UAV.

Step S202: determining an average output value of the multiple groups of actual output data and determining a mounting error angle of the accelerometer based on the average output value.

In some embodiments, after the acquisition of the actual output data of the accelerometer is completed, the actual output data may be retrieved from the storage device of the UAV. To reduce data error, an average output value of the accelerometer may be calculated based on the acquired multiple groups of actual output data. The mounting error angle of the accelerometer may be calculated based on the average output value and ideal output data.

In the present disclosure, the mounting error angle of the accelerometer may be determined based on calculating the average output value of the accelerometer. As such, more accurate actual output data of the accelerometer may be obtained. The accuracy of the ultimately determined mounting error of the accelerometer can be maintained.

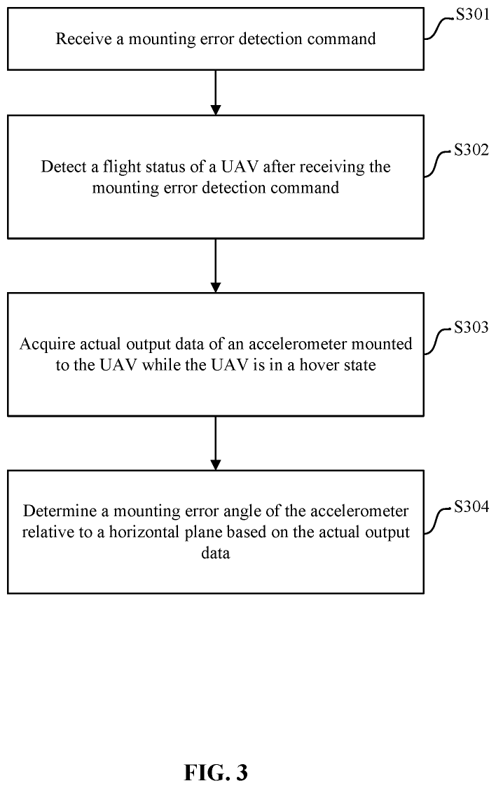

The present disclosure provides a method for detecting a mounting error of an accelerometer. FIG. 3 is a flow chart illustrating a method for detecting the mounting error of the accelerometer. As shown in FIG. 3, based on the previous embodiments, the method shown in FIG. 3 may include:

Step S301: receiving a mounting error detection command.

In some embodiments, during the process of final product inspection, when detecting a mounting error angle of the accelerometer of the UAV, a technician may send a mounting error detection command to the UAV through a control terminal. In addition, after the UAV leaves the factory, when a user is using the UAV, and when detecting the mounting error angle of the accelerometer of the UAV, the user may send the mounting error detection command to the UAV through the control terminal.

In some embodiments, the control terminal may include one or more of a remote controller, a smart cell phone, a tablet, a laptop, a wearable device (a watch or a wrist band), or a ground-based control station. The control terminal may have an interactive interface. The technician or the user may operate the interactive interface to send the mounting error detection command to the UAV.

Step S302: detecting a flight status of a UAV after receiving the mounting error detection command.

In some embodiments, after receiving the mounting error detection command, the UAV may detect the flight status. In some embodiments, a status observer may be provided in a flight control system of the UAV. The status observer may detect the flight status of the UAV based on one or more of a current flight velocity of the UAV, an altitude of the UAV, an acceleration of the UAV, an angular velocity of a body of the UAV, and a control amount received from the control terminal.

Step S303: acquiring actual output data of an accelerometer mounted to the UAV while the UAV is in a hover state.

The detailed implementation and principle of steps S303 and S101 may be the same, which are not repeated.

Step S304: determining a mounting error angle of the accelerometer relative to a horizontal plane based on the actual output data.

In some embodiments, the mounting error angle of the accelerometer may be determined based on actual output data. For example, the mounting error angle of the accelerometer relative to the horizontal plane may be determined based on the actual output data. As described above, the horizontal plane may be a plane perpendicular to the gravity of the UAV. When the UAV is in a hover state, in an ideal mounting state, the XOY plane of the accelerometer is parallel with the horizontal plane. When the UAV is in the hover state, the actual output data of the accelerometer may reflect the mounting error angle of the XOY plane of the accelerometer relative to the horizontal plane. As such, the horizontal plane is used as a reference base. The mounting error angle of the XOY plane of the accelerometer relative to the horizontal plane may be determined based on the actual output data.

In some embodiments, the mounting error angle of the accelerometer relative to the horizontal plane may be determined based on the actual output data and the output data of the accelerometer in the XOY plane in the ideal mounting state. The output data of the accelerometer in the horizontal plane in the ideal mounting state may include output data of the accelerometer in the X axis and output data of the accelerometer in the Y axis in the ideal mounting state. For the convenience of descriptions, the output data of the accelerometer in the horizontal plane in the ideal mounting state may be referred to as ideal output data. The ideal output data mentioned below may be replaced with the output data of the accelerometer in the horizontal plane in the ideal mounting state.

In some embodiments, in the ideal mounting state, when the UAV is in the hover state, the output data of the accelerometer in the XOY plane may be: both of the output data of the accelerometer in the X axis direction and the output data of the accelerometer in the Y axis direction are zero.

In some embodiments, determining the mounting error angle of the accelerometer relative to the horizontal plane based on the actual output data and the ideal output data may include determining a rotation angle for which actual output data in the XOY plane from the actual output data are rotated to convert into output data of the accelerometer in the horizontal plane in the ideal mounting state. The mounting error angle may include a rotation angle. In some embodiments, the above method may be implemented through one or more of the following practical methods:

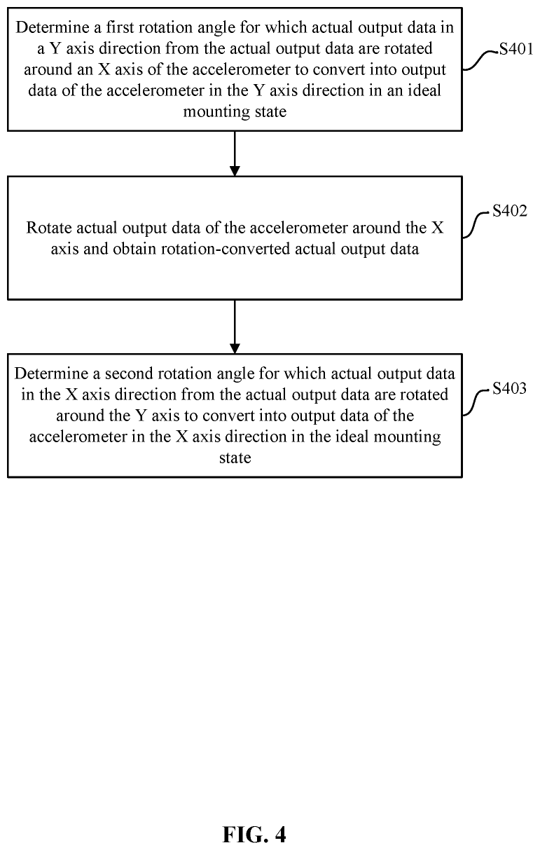

One practical method: determining the rotation angle for which actual output data in the XOY plane from the actual output data are rotated to convert into output data of the accelerometer in the horizontal plane in the ideal mounting state may include at least the following steps, as shown in FIG. 4:

Step S401: determining a first rotation angle for which actual output data in a Y axis direction from the actual output data are rotated around an X axis of the accelerometer to convert into output data of the accelerometer in the Y axis direction in an ideal mounting state.

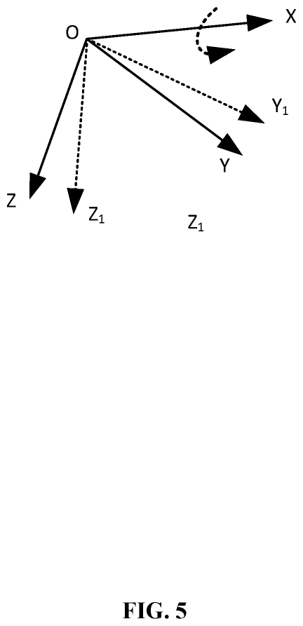

In some embodiments, as shown in FIG. 5, actual output data of the accelerometer may be rotated around the X axis of the accelerometer. When the actual output data in the Y axis direction from the actual output data are rotated around the X axis of the accelerometer to convert into the output data of the accelerometer in the Y axis direction in the ideal mounting state, the output data of the accelerometer in the Y axis direction after the rotation conversion are zero. The output data of the accelerometer in the Y axis direction after the rotation conversion may indicate that the Y axis of the accelerometer is parallel with the horizontal plane.

In some embodiments, a first rotation angle is assumed to be α, the actual output data of the accelerometer before the rotation conversion are represented by a₁=[a_{x,1} a_{y,1} a_{z,1}]^{T}, the actual output data of the accelerometer after the rotation conversion are represented by a₂[a_{x,2} a_{y,2} a_{z,2}]^{T}. Then, the first rotation angle α may be calculated based on equations (1) and (2).

$$[ \begin{matrix}{a}_{x , 2} \\ {a}_{y , 2} \\ {a}_{z , 2}\end{matrix} ] = [ \begin{matrix}1 & 0 & 0 \\ 0 & cos α & - sin α \\ 0 & sin α & cos α\end{matrix} ] [ \begin{matrix}{a}_{x , 1} \\ {a}_{y , 1} cos α - {a}_{z , 1} sin α \\ {a}_{y , 1} sin α + {a}_{z , 1} cos α\end{matrix} ] . \qquad ( 1 )$$

Because the output data of the accelerometer in the Y axis direction after rotation conversion are zero, then a_{y,2}=0, that is:

a_{y,1} cos α−a_{z,1} sin α=0 (2).

Based on equation (2), the first rotation angle may be calculated as:

$$α = arctan \frac{{a}_{y , 1}}{{a}_{z , 1}} .$$

Step S402: rotating actual output data of the accelerometer around the X axis and obtain rotation-converted actual output data.

In some embodiments, the output data of the rotation-converted actual output data in the Y axis direction are zero, the output data in the X axis and Z axis directions remain unchanged, i.e., a₂=[a_{x,2} 0 a_{z,2}]^{T}.

Step S403: determining a second rotation angle for which actual output data in the X axis direction from the actual output data are rotated around the Y axis to convert into output data of the accelerometer in the X axis direction in the ideal mounting state.

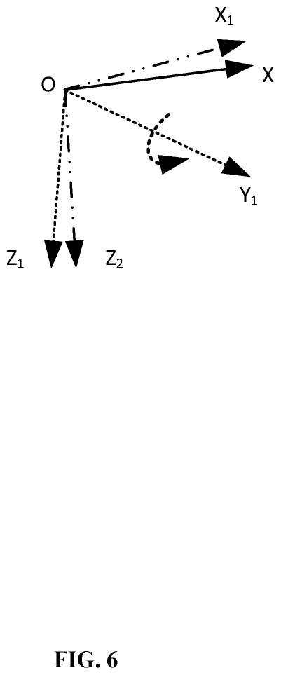

In some embodiments, as shown in FIG. 6, the rotation-converted actual output data are rotate-converted one more time around the Y axis of the accelerometer. When the actual output data of the rotation-converted actual output data in the X axis direction are rotation-converted around the Y axis of the accelerometer into output data of the accelerometer in the X axis direction in the ideal mounting state, the output data of the accelerometer in the X axis direction after the rotation conversion are zero. The output data of the accelerometer in the X axis direction after the one more rotation conversion may indicate that the X axis of the accelerometer is parallel with the horizontal plane.

In some embodiments, the second rotation angle is assumed to be β. After being rotated around the X axis for the first rotation angle α, the actual output data of the accelerometer may be:

$${a}_{2} = [ \begin{matrix}{a}_{x , 2} \\ {a}_{y , 2} \\ {a}_{z , 2}\end{matrix} ] = [ \begin{matrix}{a}_{x , 1} \\ {a}_{y , 1} cos α - {a}_{z , 1} sin α \\ {a}_{y , 1} sin α + {a}_{z , 1} cos α\end{matrix} ] = [ \begin{matrix}{a}_{x , 1} \\ 0 \\ {a}_{y , 1} sin α + {a}_{z , 1} cos α\end{matrix} ] .$$

In some embodiments, assuming that on the basis of rotating the actual output data of the accelerometer around the X axis for the first rotation angle α, the actual output data are again rotated around the Y axis for the second rotation angle β, then the actual output data of the accelerometer may be presented by a₃=[a_{x,3} a_{y,3} a_{z,3}]^{T}. Then, the second rotation angle β may be calculated based on equations (3) and (4).

$$\begin{matrix}[ \begin{matrix}{a}_{x , 3} \\ {a}_{y , 3} \\ {a}_{z , 3}\end{matrix} ] = [ \begin{matrix}cos β & 0 & sin β \\ 0 & 1 & 0 \\ - sin β & 0 & cos β\end{matrix} ] [ \begin{matrix}{a}_{x , 1} \\ 0 \\ {a}_{y , 1} sin α + {a}_{z , 1} cos α\end{matrix} ] \\ = [ \begin{matrix}{a}_{x , 1} cos β + {a}_{y , 1} sin α sin β + {a}_{z , 1} cos α sin β \\ 0 \\ - {a}_{x , 1} sin β + {a}_{y , 1} sin α cos β + {a}_{z , 1} cos α sin β\end{matrix} ]\end{matrix} . \qquad ( 3 )$$

Because the output data of the accelerometer in the X axis direction after the rotation conversion are zero, then a_{x,3}=0, i.e.,

a_{x,1} cos β+a_{y,1} sin αsin β+a_{z,1} cos αsin β=0 (4).

The second rotation angle β may be calculated based on the equation (4) to be:

$$β = - arctan \frac{{a}_{x , 1}}{{a}_{z , 1} cos α + {a}_{y , 1} sin α} .$$

In some embodiments, the mounting error angle may include the first rotation angle and the second rotation angle.

In the technical solutions of the present disclosure, the actual output data of the accelerometer are first rotated around the X axis for the first rotation angle, and then rotated around the Y axis for the second rotation angle to obtain a rotation angle for which the actual output data in the XOY plane from the actual output data are rotated to convert into output data of the accelerometer in the ideal mounting state may be obtained. After the two rotation conversions, the data obtained after the rotation conversions may indicate that the XOY plane of the accelerometer is parallel with the horizontal plane.

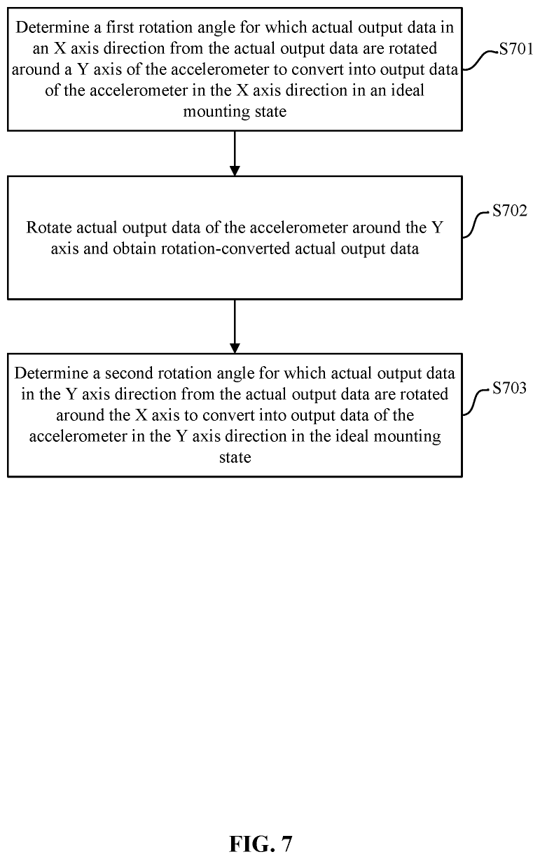

Another practical method: determining the rotation angle for which the actual output data in the XOY plane from the actual output data are rotation-converted into the output data of the accelerometer in the horizontal plane in the ideal mounting state may include at least the following steps, as shown in FIG. 7:

Step S701: determining a first rotation angle for which actual output data in an X axis direction from the actual output data are rotated around a Y axis of the accelerometer to convert into output data of the accelerometer in the X axis direction in an ideal mounting state.

In some embodiments, the actual output data of the accelerometer may be rotated around the Y axis of the accelerometer. When the actual output data in the X axis direction from the actual output data are rotated around the Y axis of the accelerometer to convert into the output data of the accelerometer in the X axis direction in the ideal mounting state, the output data of the accelerometer in the X axis direction after the rotation conversion are zero. The output data of the accelerometer in the Y axis direction after the rotation conversion may indicate that the X axis of the accelerometer is parallel with the horizontal plane.

In some embodiments, the first rotation angle may be assumed to be α. The actual output data of the accelerometer before the rotation conversion may be represented by a₁=[a_{x,1} a_{y,1} a_{z,1}]^{T}. The output data of the accelerometer after the rotation conversion may be represented by a₂=[a_{x,2} a_{y,2} a_{z,2}]^{T}. Then, the first rotation angle α may be calculated based on equations (5) and (6).

$$[ \begin{matrix}{a}_{x , 2} \\ {a}_{y , 2} \\ {a}_{z , 2}\end{matrix} ] = [ \begin{matrix}cos α & 0 & sin α \\ 0 & 1 & 0 \\ - sin α & 0 & cos α\end{matrix} ] [ \begin{matrix}{a}_{x , 1} \\ {a}_{y , 1} \\ {a}_{z , 1}\end{matrix} ] = [ \begin{matrix}{a}_{x , 1} cos α + {a}_{z , 1} sin α \\ {a}_{y , 1} \\ - {a}_{x , 1} sin α + {a}_{z , 1} cos α\end{matrix} ] . \qquad ( 5 )$$

Because the output data of the accelerometer in the X axis direction after the rotation conversion are zero, then a_{x,2}=0, i.e.:

a_{x,1} cos α+a_{z,1} sin α=0 (6).

The first rotation angle may be calculated from equation (6) as:

$$α = - arctan \frac{{a}_{x , 1}}{{a}_{z , 1}} .$$

Step S702: rotating actual output data of the accelerometer around the Y axis and obtaining rotation-converted actual output data.

In some embodiments, the output data of the rotation-converted actual output data in the X axis direction are zero, and the output data in the Y axis and Z axis directions remain unchanged, i.e., a₂=[0 a_{y,2} a_{z,2}]^{T}.

Step S703: determining a second rotation angle for which actual output data in the Y axis direction from the actual output data are rotated around the X axis to convert into output data of the accelerometer in the Y axis direction in the ideal mounting state.

In some embodiments, the rotation-converted actual output data may be rotated one more time around the X axis of the accelerometer. When the actual output data in the Y axis direction from the rotation-converted actual output data are rotate-converted around the X axis of the accelerometer into the output data of the accelerometer in the Y axis direction in the ideal mounting state, the output data of the accelerometer in the Y axis direction after the rotation conversion are zero. Then, the output data of the accelerometer in the Y axis direction after the one more rotation conversion may indicate that the Y axis of the accelerometer is parallel with the horizontal plane.

In some embodiments, the second rotation angle may be assumed to be β. After being rotated around the Y axis for the first rotation angle α, the actual output data of the accelerometer may be represented by:

$${a}_{2} = [ \begin{matrix}{a}_{x , 2} \\ {a}_{y , 2} \\ {a}_{z , 2}\end{matrix} ] = [ \begin{matrix}{a}_{x , 1} cos α + {a}_{z , 1} sin α \\ {a}_{y , 1} \\ - {a}_{x , 1} sin α + {a}_{z , 1} cos α\end{matrix} ] = [ \begin{matrix}0 \\ {a}_{y , 1} \\ - {a}_{x , 1} sin α + {a}_{z , 1} cos α\end{matrix} ] .$$

Assuming that on the basis of rotating the actual output data of the accelerometer around the Y axis for the first rotation angle α, and around the X axis for the second rotation angle β, the actual output data of the accelerometer may be represented by: a₃=[a_{x,3} a_{y,3} a_{z,3}]^{T}, then the second rotation angle β may be calculated based on equations (7) and (8).

$$\begin{matrix}[ \begin{matrix}{a}_{x , 3} \\ {a}_{y , 3} \\ {a}_{z , 3}\end{matrix} ] = [ \begin{matrix}1 & 0 & 0 \\ 0 & cos β & - sin β \\ 0 & sin β & cos β\end{matrix} ] [ \begin{matrix}0 \\ {a}_{y , 1} \\ - {a}_{x , 1} sin α + {a}_{z , 1} cos α\end{matrix} ] \\ = [ \begin{matrix}0 \\ {a}_{y , 1} cos β - ( - {a}_{x , 1} sin α + {a}_{z , 1} cos α ) sin β \\ {a}_{y , 1} sin β + ( - {a}_{x , 1} sin α + {a}_{z , 1} cos α ) cos β\end{matrix} ]\end{matrix} . \qquad ( 7 )$$

Because the output data of the accelerometer in the Y axis direction after the rotation conversion are zero, then, a_{y,3}=0, i.e.:

a_{y,1} cos β−(−a_{x,1} sin α+a_{z,1} cos α) sin β=0 (8).

The second rotation angle may be calculated based on equation (8) to be:

$$β = arctan \frac{{a}_{y , 1}}{- {a}_{x , 1} sin α + {a}_{z , 1} cos α} .$$

In some embodiments, the mounting error angle may include the first rotation angle and the second rotation angle.

In the technical solutions of the present disclosure, the actual output data of the accelerometer may be rotated around the Y axis for the first rotation angle, and then rotated around the X axis for the second rotation angle to obtain a rotation angle for which the actual output data in the XOY plane from the actual output data are rotate-converted into the output data of the accelerometer in the horizontal plane in the ideal mounting state. After the two rotation conversions, the rotate-converted data may indicate that the XOY plane of the accelerometer is parallel with the horizontal plane.

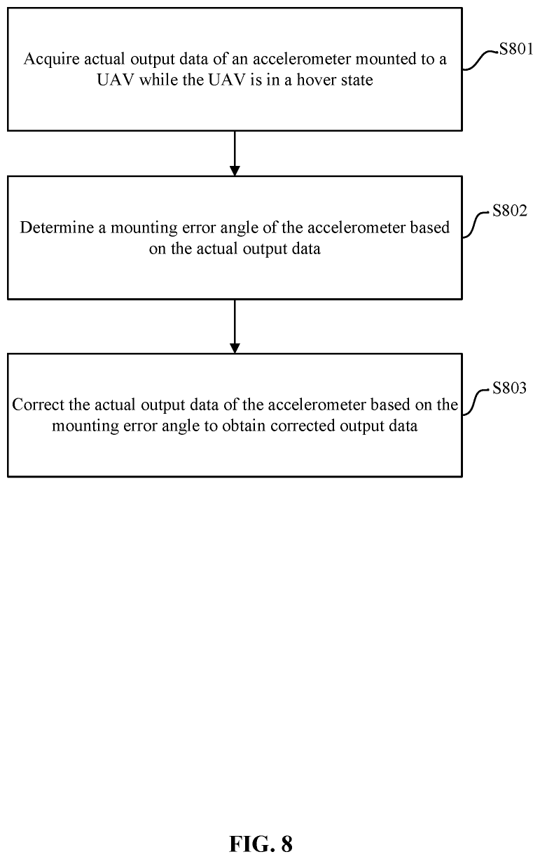

The present disclosure provides a method for detecting a mounting error of an accelerometer. FIG. 8 is a flow chart illustrating a method for detecting a mounting error of an accelerometer. As shown in FIG. 8, on the basis of the previous embodiments, the method shown in FIG. 8 may include:

Step S801: acquiring actual output data of an accelerometer mounted to a UAV while the UAV is in a hover state.

The detailed implementation and the principle of step S801 and step S101 may be the same, which are not repeated.

Step S802: determining a mounting error angle of the accelerometer based on the actual output data.

The detailed implementation and the principle of step S802 and step S102 may be the same, which are not repeated.

Step S803: correcting the actual output data of the accelerometer based on the mounting error angle to obtain corrected output data.

In some embodiments, after determining the mounting error angle based on the actual output data of the accelerometer, i.e., after the mounting error angle is known, in the subsequent operations of the UAV, the actual output data may be corrected based on the mounting error angle to obtain corrected output data. The corrected output data may be provided to various functional units of the UAV, such as the flight control device, etc., to improve the control accuracy of the UAV.

In some embodiments, assuming the mounting error angle of the accelerometer includes the first rotation angle α and the second rotation angle β. The actual output data before correction may be represented by aᵢ=[a_{x,i} a_{y,i} a_{z,i}]^{T}. The corrected actual output data may be calculated based on equation (9) to be: aₒ=[a_{x,o} a_{y,o} a_{z,o}]^{T}.

$$[ \begin{matrix}{a}_{x , o} \\ {a}_{y , o} \\ {a}_{z , o}\end{matrix} ] = [ \begin{matrix}1 & 0 & 0 \\ 0 & cos β & - sin β \\ 0 & sin β & cos β\end{matrix} ] [ \begin{matrix}cos α & 0 & sin α \\ 0 & 1 & 0 \\ - sin α & 0 & cos α\end{matrix} ] [ \begin{matrix}{a}_{x , i} \\ {a}_{y , i} \\ {a}_{z , i}\end{matrix} ] . \qquad ( 9 )$$

In some embodiments, the first rotation angle α is a rotation angle for which the actual output data in the X axis direction from the actual output data are rotated around the Y axis of the accelerometer to convert into the output data of the accelerometer in the X axis direction in the ideal mounting state. The second rotation angle β is a rotation angle for which the actual output data in the Y axis direction from the rotation-converted actual output data are rotation-converted around the X axis of the accelerometer into the output data of the accelerometer in the Y axis direction in the ideal mounting state.

In some embodiments, assuming that the mounting error angle of the accelerometer includes the first rotation angle α and the second rotation angle β, the actual output data before correction may be represented by aᵢ=[a_{x,i} a_{y,i} a_{z,i}]^{T}, then the corrected actual output data may be calculated based on equation (10) to be: aₒ=[a_{x,o} a_{y,o} a_{z,o}]^{T}.

$$[ \begin{matrix}{a}_{x , o} \\ {a}_{y , o} \\ {a}_{z , o}\end{matrix} ] = [ \begin{matrix}cos β & 0 & sin β \\ 0 & 1 & 0 \\ - sin β & 0 & cos β\end{matrix} ] [ \begin{matrix}1 & 0 & 0 \\ 0 & cos α & - sin α \\ 0 & sin α & cos α\end{matrix} ] [ \begin{matrix}{a}_{x , i} \\ {a}_{y , i} \\ {a}_{z , i}\end{matrix} ] . \qquad ( 10 )$$

In some embodiments, the first rotation angle α is a rotation angle for which the actual output data in the Y axis direction from the actual output data are rotation-converted around the X axis of the accelerometer into output data of the accelerometer in the Y axis direction in the ideal mounting state. The second rotation angle β is a rotation angle for which the actual output data in the X axis direction from the rotation-converted actual output data are rotation-converted around the Y axis of the accelerometer into the output data of the accelerometer in the X axis direction in the ideal mounting state.

In the technical solutions of the present disclosure, after the mounting error angle of the accelerometer is determined, the actual output data of the accelerometer may be corrected, thereby maintaining the accuracy of the output data of the accelerometer, and maintaining the safety of the user.

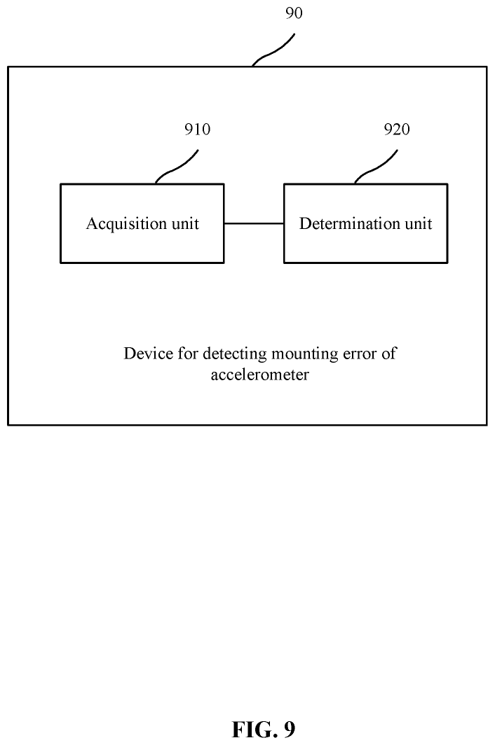

The present disclosure provides a device for detecting a mounting error of an accelerometer. FIG. 9 is a schematic diagram of a device 90 for detecting a mounting error of an accelerometer. As shown in FIG. 9, the device 90 may include:

an acquisition unit 910 configured to acquire actual output data of the accelerometer mounted to the UAV while the UAV is in a hover state.

a determination unit 920 configured to determine a mounting error angle of the accelerometer based on the actual output data acquired by the acquisition unit 910.

In some embodiments, the acquisition unit 910 may be configured to acquire multiple groups of actual output data of the accelerometer mounted to the UAV while the UAV is in the hover state.

In some embodiments, the determination unit 920 may be configured to determine an average output value based on the multiple groups of actual output data, and determine the mounting error angle of the accelerometer based on the average output value.

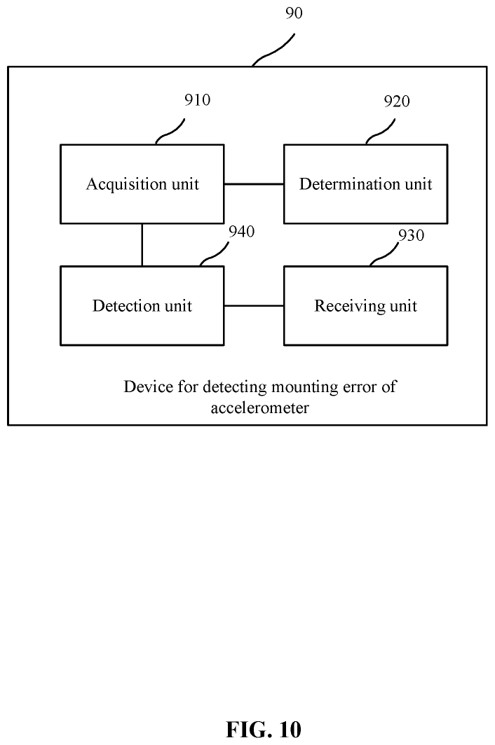

In some embodiments, the present disclosure also provides another device for detecting the mounting error of the accelerometer. As shown in FIG. 10, besides the acquisition unit 910 and the determination unit 920, the device 90 may also include the following units:

a receiving unit 930 configured to receive a mounting error detection command.

a detection unit 940 configured to detect a flight status of the UAV in response to (or after, when, based on) receiving the mounting error detection command.

In some embodiments, the determination unit 920 may be configured to determine the mounting error angle of the accelerometer relative to a horizontal plane based on the actual output data.

In some embodiments, the determination unit 920 may be configured to determine the mounting error angle of the accelerometer relative to the horizontal plane based on the actual output data and output data of the accelerometer in the horizontal plane in an ideal mounting state.

In some embodiments, the output data of the accelerometer in the horizontal plane in the ideal mounting state may include output data of the accelerometer in the X axis direction and output data of the accelerometer in the Y axis direction in the ideal mounting state. The output data in the X axis direction and the output data in the Y axis direction may both be zero.

In some embodiments, the determination unit 920 may be configured to determine a rotation angle for which actual output data in the XOY plane from the actual output data are rotation-converted into output data of the accelerometer in the horizontal plane in the ideal mounting state. The mounting error angle may include the rotation angle.

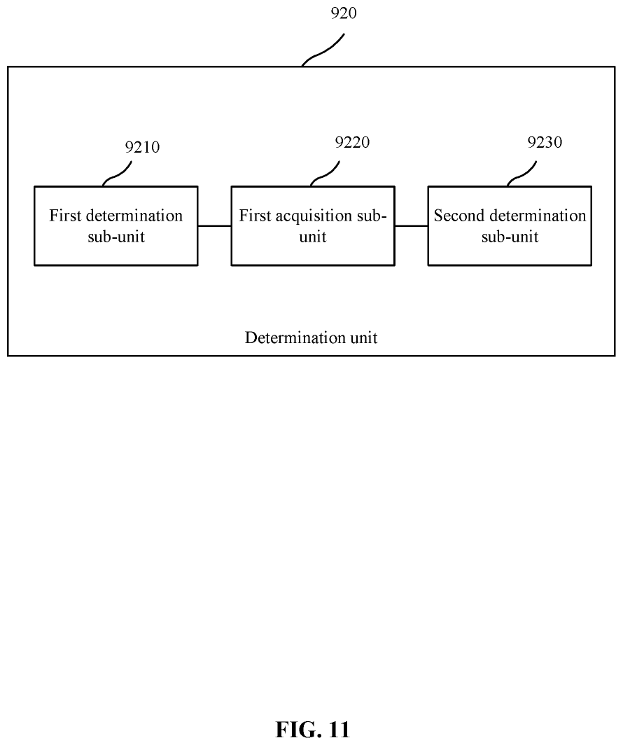

In some embodiments, the present disclosure provides a determination unit. As shown in FIG. 11, the determination unit 920 may include at least the following sub-units:

a first determination sub-unit 9210 configured to determine a first rotation angle for which actual output data in the X axis direction from the actual output data are rotated around the Y axis of the accelerometer to convert into output data of the accelerometer in the X axis in an ideal mounting state.

a first acquisition sub-unit 9220 configured to obtain rotation-converted actual output data after the actual output data of the accelerometer are rotated around the Y axis the first rotation angle.

a second determination sub-unit 9230 configured to determine a second rotation angle for which actual output data in the Y axis direction from the rotation-converted actual output data are rotated around the X axis of the accelerometer to convert into output data of the accelerometer in the Y axis direction in the ideal mounting state.

In some embodiments, the mounting error angle may include the first rotation angle and the second rotation angle.

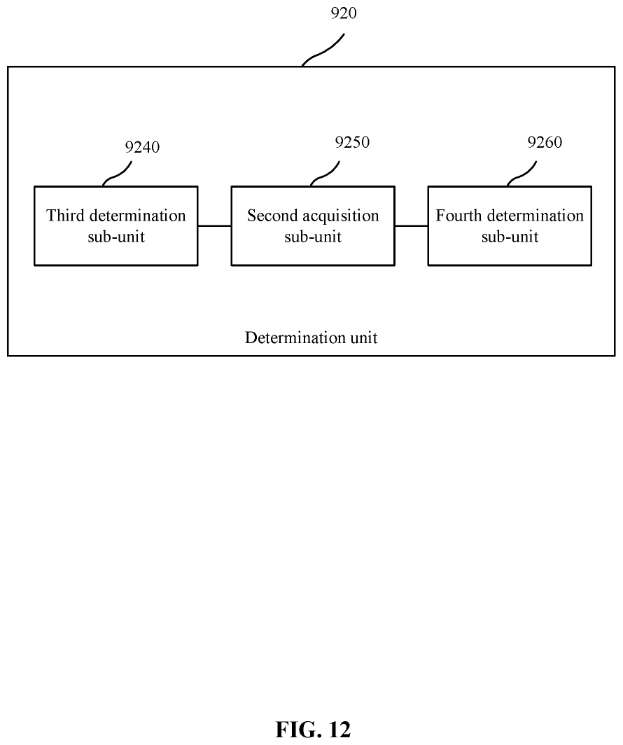

In some embodiments, the present disclosure provides another determination unit. As shown in FIG. 12, the determination unit 920 may include at least the following sub-units:

a third determination sub-unit 9240 configured to determine a first rotation angle for which actual output data in the Y axis direction from the actual output data are rotated around the X axis of the accelerometer to convert into output data of the accelerometer in the Y axis direction in the ideal mounting state.

a second acquisition sub-unit 9250 configured to obtain rotation-converted actual output data after the actual output data of the accelerometer are rotated around the X axis for the first rotation angle.

a fourth determination sub-unit 9260 configured to determine a second rotation angle for which actual output data in the X axis direction from the rotation-converted actual output data are rotated around the Y axis of the accelerometer to convert into output data of the accelerometer in the X axis direction in the ideal mounting state.

In some embodiments, the mounting error angle may include the first rotation angle and the second rotation angle.

In some embodiments, the device 90 for detecting the mounting error of the accelerometer may include a correction unit configured to correct actual output data of the accelerometer based on the mounting error angle to obtain corrected output data.

According to the technical solutions of the present disclosure, the mounting error angle of the accelerometer may be determined based on actual output data of the accelerometer acquired while the UAV is in the hover state. The mounting error of the accelerometer may be detected after the accelerometer has been mounted in the UAV. In some embodiments, the mounting error of the accelerometer may be detected in real time. After the mounting error is detected, actual output data of the accelerometer may be corrected. The correction of the accelerometer may be performed through software programs. This method may eliminate or reduce errors in the actual output data which may be caused due to the mounting error of the accelerometer. Even if there is a certain amount of mounting error angle in the accelerometer, through the disclosed correction method, accurate output data may still be obtained, which reduces the requirement on the mounting precision of the accelerometer and reduces the manufacturing cost.

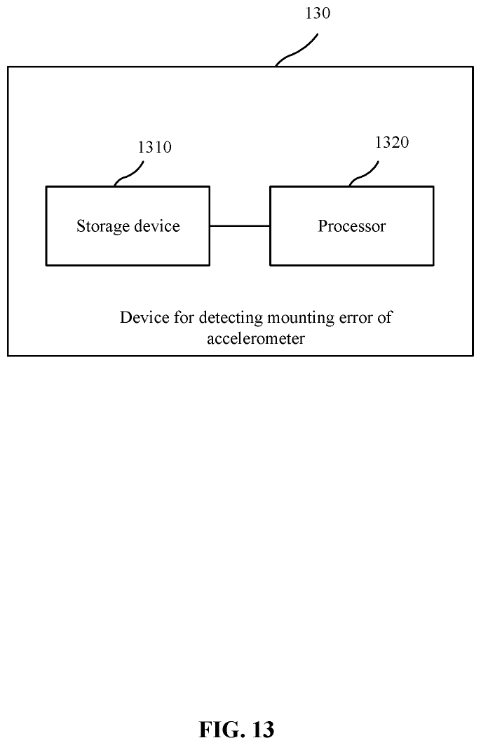

The present disclosure provides a device for detecting a mounting error of an accelerometer. FIG. 13 is a schematic diagram of a device for detecting a mounting error of an accelerometer. As shown in FIG. 13, the device may include a storage device 1310 and a processor 1320.

In some embodiments, the storage device 1310 may be configured to store program instructions.

In some embodiments, the processor 1320 may be configured to retrieve the program instructions stored in the storage device 1310, and may execute the instructions to perform the following operations:

acquiring actual output data of the accelerometer mounted to the UAV while the UAV is in a hover state; and

determining a mounting error angle of the accelerometer based on the actual output data.

In some embodiments, the processor 1320 may be configured to acquire multiple groups actual output data of the accelerometer mounted to the UAV while the UAV is in a hover state; determine an average output value of the multiple groups of actual output data; and determine the mounting error angle of the accelerometer based on the average output value.

In some embodiments, the processor 1320 may be configured to receive a mounting error detection command before acquiring the actual output data of the accelerometer mounted to the UAV while the UAV is in the hover state; and detect a flight status of the UAV in response to (or after, when, based on) receiving the mounting error detection command.

In some embodiments, when the processor 1320 determines the mounting error angle of the accelerometer based on the actual output data, the processor 1320 may be configured to determine the mounting error angle of the accelerometer relative to a horizontal plane based on the actual output data.

In some embodiments, when the processor 1320 determines the mounting error angle of the accelerometer relative to the horizontal plane based on the actual output data, the processor 1320 may be configured to the mounting error angle of the accelerometer relative to the horizontal plane based on the actual output data and output data of the accelerometer in the horizontal plane in an ideal mounting state.

In some embodiments, the output data of the accelerometer in the horizontal plane in the ideal mounting state may include: output data of the accelerometer in the X axis direction and output data in the Y axis direction in the ideal mounting state. The output data in the X axis direction and the output data in the Y axis direction may both be zero.

In some embodiments, when the processor 1320 determines the mounting error angle of the accelerometer relative to the horizontal plane based on the actual output data and the output data of the accelerometer in the horizontal plane in the ideal mounting state, the processor 1320 may be configured to a rotation angle for which actual output data in the XOY plane from the actual output data are rotation-converted into output data of the accelerometer in the horizontal plane in the ideal mounting state. The mounting error angle may include the rotation angle.

In some embodiments, when the processor 1320 determines the rotation angle for which the actual output data in the XOY plane from the actual output data are rotation-converted into the output data of the accelerometer in the horizontal plane in the ideal mounting state, where the mounting error angle includes the rotation angle, the processor 1320 may be configured to determine a first rotation angle for which actual output data in the X axis direction from the actual output data are rotated around the Y axis of the accelerometer to convert into output data of the accelerometer in the X axis direction in the ideal mounting state; rotate the actual output data of the accelerometer around the Y axis for the first rotation angle to obtain rotation-converted actual output data; determine a second rotation angle for which actual output data in the Y axis from the rotation-converted actual output data are rotated around the X axis of the accelerometer to convert into output data of the accelerometer in the Y axis in the ideal mounting state. The mounting error angle may include the first rotation angle and the second rotation angle.

In some embodiments, when the processor 1320 determines the rotation angle for which the actual output data in the XOY plane from the actual output data are rotation-converted into the output data of the accelerometer in the horizontal plane in the ideal mounting state, where the mounting error angle includes the rotation angle, the processor 1320 may be configured to determine a first rotation angle for which actual output data in the Y axis from the actual output data are rotated around the X axis of the accelerometer to convert into the output data of the accelerometer in the Y axis direction in the ideal mounting state; rotate the actual output data of the accelerometer around the X axis for the first rotation angle to obtain rotation-converted actual output data; determine a second rotation angle for which actual output data in the X axis direction from the rotation-converted actual output data are rotated around the Y axis of the accelerometer to convert into output data of the accelerometer in the X axis direction in the ideal mounting state. The mounting error angle may include the first rotation angle and the second rotation angle.

In some embodiments, after determining the mounting error angle of the accelerometer based on the actual output data, the processor 1320 may be configured to correct the actual output data of the accelerometer based on the mounting error angle to obtain corrected output data.

According to the technical solutions of the present disclosure, the mounting error angle of the accelerometer may be determined based on actual output data of the accelerometer acquired while the UAV is in a hover state. Detecting the mounting error of the accelerometer after the accelerometer has been installed in the UAV can realize real time detection of the mounting error of the accelerometer. After the mounting error angle is detected, the actual output data of the accelerometer may be corrected to maintain safety of the user.

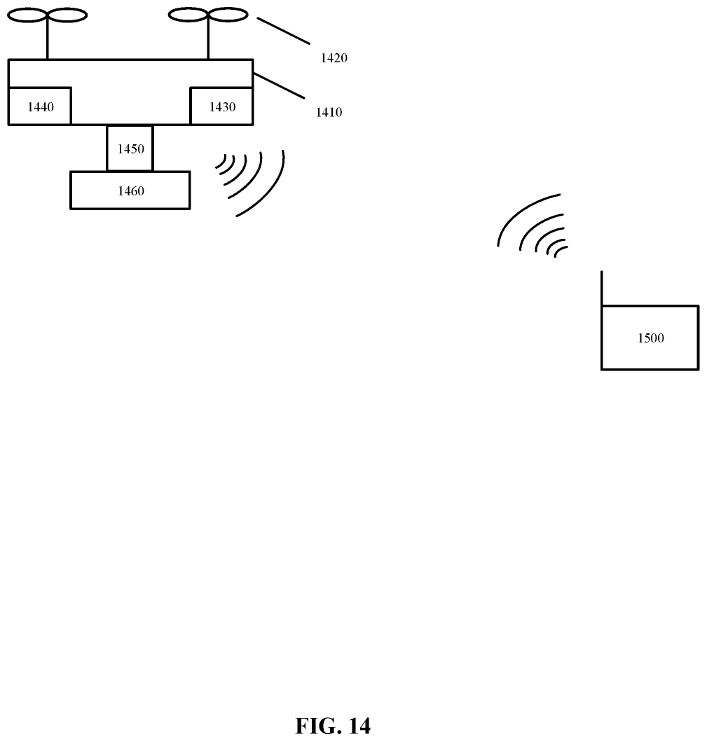

The present disclosure provides a UAV. FIG. 14 is a schematic diagram of the UAV. As shown in FIG. 14, the UAV may include:

a body 1410;

a propulsion system 1420 mounted on the body 1410 and configured to provide a flight propulsion; and

a device 1430 configured to detect a mounting error of an accelerometer.

In some embodiments, the UAV may also include an accelerometer 1440 configured to sense an acceleration of the UAV. The propulsion system may include one or more of a propeller, a motor, an electric speed control. The device for detecting the mounting error of the accelerometer may be configured to detect a mounting error angle of the accelerometer, and to correct the actual output data of the accelerometer as described above. The UAV may also include a gimbal 1450 and an imaging device 1460. The imaging device 1460 may be carried by the main frame of the UAV through the gimbal 1450. The imaging device 1460 may be configured to capture images or videos during a flight of the UAV. The imaging device 1460 may include one or more of a multispectral imaging device, a hyperspectral imaging device, a visible light camera, an infrared camera, etc. The gimbal 1450 may be a multi-axis transmission and stabilizing system. A motor of the gimbal may be configured to adjust a rotation angle of a rotation axis to compensate for the imaging angle of the imaging device 1460. A suitable damping structure may be included in the gimbal to reduce or eliminate shaking of the imaging device 1460. In some embodiments, the UAV may receive a control command from a control terminal 1500, such as a mounting error detection command, and may control various components of the UAV to perform corresponding actions based on the command.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

The integrated units realized through software functional units may be stored in a non-transitory computer-readable storage medium. The software functional units stored in a storage medium may include a plurality of instructions configured to instruct a computing device (which may be a personal computer, a server, or a network device, etc.) or a processor to execute some or all of the steps of the various embodiments of the disclosed method. The storage medium may include any suitable medium that can store program codes or instructions, such as at least one of a U disk (e.g., flash memory disk), a mobile hard disk, a read-only memory (“ROM”), a random access memory (“RAM”), a magnetic disk, or an optical disc.

A person having ordinary skill in the art can appreciate that for convenience and simplicity, the above descriptions described the division of the functioning units. In practical applications, the disclosed functions may be realized by various functioning units. For example, in some embodiments, the internal structure of a device may be divided into different functioning units to realize all or part of the above-described functions. The detailed operations and principles of the device are similar to those described above, which are not repeated.

The above embodiments are only examples of the present disclosure, and do not limit the scope of the present disclosure. Although the technical solutions of the present disclosure are explained with reference to the above-described various embodiments, a person having ordinary skills in the art can understand that the various embodiments of the technical solutions may be modified, or some or all of the technical features of the various embodiments may be equivalently replaced. Such modifications or replacement do not render the spirit of the technical solutions falling out of the scope of the various embodiments of the technical solutions of the present disclosure.

What is claimed is:

1. A method for detecting a mounting error of an accelerometer, comprising:
acquiring actual output data of the accelerometer mounted to an unmanned aerial vehicle (“UAV”) while the UAV is in a hover state; and
determining a mounting error angle of the accelerometer based on the actual output data.

2. The method of claim 1,
wherein acquiring the actual output data of the accelerometer mounted to the UAV comprises:
acquiring multiple groups of actual output data of the accelerometer mounted to the UAV, and
wherein determining the mounting error angle of the accelerometer based on the actual output data comprises:
determining an average output value of the multiple groups of actual output data and determining the mounting error angle of the accelerometer based on the average output value.

3. The method of claim 1, wherein prior to acquiring the actual output data of the accelerometer mounted to the UAV while the UAV is in a hover state comprises:
receiving a mounting error detection command; and
detecting a flight status of the UAV in response to receiving the mounting error detection command.

4. The method of claim 1, wherein determining the mounting error angle based on the actual output data comprises:
determining the mounting error angle of the accelerometer relative to a horizontal plane based on the actual output data.

5. The method of claim 4, wherein determining the mounting error angle of the accelerometer relative to the horizontal plane based on the actual output data comprises:
determining the mounting error angle of the accelerometer relative to the horizontal plane based on the actual output data and output data of the accelerometer in the horizontal plane in an ideal mounting state.

6. The method of claim 5, wherein the output data of the accelerometer in the horizontal plane in the ideal mounting state comprise:
output data of the accelerometer in an X axis direction and output data of the accelerometer in a Y axis direction in the ideal mounting state,
wherein the output data in the X axis direction and the output data in the Y axis direction are zero.

7. The method of claim 5, wherein determining the mounting error angle of the accelerometer relative to the horizontal plane based on the actual output data and the output data of the accelerometer in the horizontal plane in the ideal mounting state comprises:
determining a rotation angle for which actual output data in an XOY plane from the actual output data of the accelerometer are rotation-converted into output data of the accelerometer in the horizontal plane in the ideal mounting state,
wherein the mounting error angle comprises the rotation angle.

8. The method of claim 7, wherein determining the rotation angle for which the actual output data in the XOY plane from the actual output data of the accelerometer are rotation-converted into the output data of the accelerometer in the horizontal plane in the ideal mounting state comprises:
determining a first rotation angle for which actual output data in an X axis direction from the actual output data of the accelerometer are rotated around a Y axis of the accelerometer to convert into output data of the accelerometer in the X axis direction in the ideal mounting state;
rotating the actual output data of the accelerometer around the Y axis for the first rotation angle to obtain rotation-converted actual output data; and
determining a second rotation angle for which actual output data in a Y axis direction from the rotation-converted actual output data are rotated around an X axis to convert into output data of the accelerometer in the Y axis direction in the ideal mounting state,
wherein the mounting error angle comprises the first rotation angle and the second rotation angle.

9. The method of claim 7, wherein determining the rotation angle for which the actual output data in the XOY plane from the actual output data of the accelerometer are rotation-converted into the output data of the accelerometer in the horizontal plane in the ideal mounting state comprises:
determining a first rotation angle for which actual output data in a Y axis direction from the actual output data of the accelerometer are rotated around an X axis of the accelerometer to convert into output data of the accelerometer in the Y axis direction in the ideal mounting state;
rotating the actual output data of the accelerometer around the X axis for the first rotation angle to obtain rotation-converted actual output data; and
determining a second rotation angle for which actual output data in an X axis direction from the rotation-converted actual output data are rotated around a Y axis of the accelerometer to convert into output data of the accelerometer in the X axis direction in the ideal mounting state,
wherein the mounting error angle comprises the first rotation angle and the second rotation angle.

10. The method of claim 1, wherein after determining the mounting error angle based on the actual output data, the method further comprises:
correcting the actual output data of the accelerometer based on the mounting error angle to obtain corrected output data.

11. A device for detecting a mounting error of an accelerometer, comprising:
a storage device configured to store program instructions; and
a processor configured to retrieve the program instructions stored in the storage device, and to execute the program instructions to:
acquire actual output data of the accelerometer mounted to an unmanned aerial vehicle (“UAV”) while the UAV is in a hover state; and
determine a mounting error angle of the accelerometer based on the actual output data.

12. The device of claim 11, wherein when the processor acquires the actual output data of the accelerometer mounted to the UAV, the processor is also configured to execute the program instructions to:
acquire multiple groups of actual output data of the accelerometer mounted to the UAV,
wherein determining the mounting error angle of the accelerometer based on the actual output data comprises:
determining an average output value of the multiple groups of actual output data, and determining the mounting error angle of the accelerometer based on the average output value.

13. The device of claim 11, the processor is also configured to execute the program instructions to:
prior to acquiring the actual output data of the accelerometer mounted to the UAV while the UAV is in the hover state:
receive a mounting error detection command; and
detect a flight status of the UAV in response to receiving the mounting error detection command.

14. The device of claim 11, wherein when the processor determines the mounting error angle based on the actual output data, the processor is configured to execute the program instructions to:
determine the mounting error angle of the accelerometer relative to a horizontal plane based on the actual output data.

15. The device of claim 14, wherein when the processor determines the mounting error angle of the accelerometer relative to the horizontal plane based on the actual output data, the processor is configured to execute the program instructions to:
determine the mounting error angle of the accelerometer relative to the horizontal plane based on the actual output data and output data of the accelerometer relative to the horizontal plane in an ideal mounting state.

16. The device of claim 15, wherein the output data of the accelerometer in the horizontal plane in the ideal mounting state comprises:
output data of the accelerometer in an X axis direction and output data of the accelerometer in a Y axis direction in the ideal mounting state,
wherein the output data in the X axis direction and the output data in the Y axis direction are zero.

17. The device of claim 15, wherein when the processor determines the mounting error angle of the accelerometer relative to the horizontal plane based on the actual output data and the output data of the accelerometer in the horizontal plane in the ideal mounting state, the processor is configured to execute the program instructions to:
determine a rotation angle for which actual output data in an XOY plane from the actual output data of the accelerometer are rotation-converted into output data of the accelerometer in the horizontal plane in the ideal mounting state,
wherein the mounting error angle comprises the rotation angle.

18. The device of claim 17, wherein when the processor determines the rotation angle for which the actual output data in the XOY plane from the actual output data of the accelerometer are rotation-converted into the output data of the accelerometer in the horizontal plane in the ideal mounting state, the processor is configured to execute the program instructions to:
determine a first rotation angle for which actual output data in an X axis direction from the actual output data of the accelerometer are rotated around a Y axis of the accelerometer to convert into output data of the accelerometer in the X axis direction in the ideal mounting state;
rotate the actual output data of the accelerometer around the Y axis for the first rotation angle to obtain rotation-converted actual output data; and
determine a second rotation angle for which actual output data in a Y axis direction from the rotation-converted actual output data are rotated around an X axis of the accelerometer to convert into output data of the accelerometer in the Y axis direction in the ideal mounting state,
wherein the mounting error angle comprises the first rotation angle and the second rotation angle.

19. The device of claim 17, wherein when the processor determines the rotation angle for which the actual output data in the XOY plane from the actual output data of the accelerometer are rotation-converted into the output data of the accelerometer in the horizontal plane in the ideal mounting state, the processor is configured to execute the program instructions to:
determine a first rotation angle for which actual output data in a Y axis direction from the actual output data of the accelerometer are rotated around an X axis of the accelerometer to convert into output data of the accelerometer in the Y axis direction in the ideal mounting state;
rotate the actual output data of the accelerometer around the X axis for the first rotation angle to obtain rotation-converted actual output data; and
determine a second rotation angle for which actual output data in an X axis direction from the rotation-converted actual output data are rotated around a Y axis to convert into output data of the accelerometer in the X axis direction in the ideal mounting state,
wherein the mounting error angle comprises the first rotation angle and the second rotation angle.

20. The device of claim 11, wherein the processor is configured to execute the program instructions to:
after determining the mounting error angle based on the actual output data, correct the actual output data of the accelerometer based on the mounting error angle to obtain corrected output data.
